(19) United States
(12) Patent Application Publication
(10) Pub. No.: US 2026/0084851 A1
(43) Pub. Date: Mar. 26, 2026

(54) AUTOMATED PACKAGING SYSTEM FOR PRESCRIPTIONS

(71) Applicant: ATS Corporation, Cambridge (CA)

(72) Inventor: Stephen WILSON, Cambridge (CA)

(21) Appl. No.: 19/336,952

(22) Filed: Sep. 23, 2025

Related U.S. Application Data
(60) Provisional application No. 63/697,774, filed on Sep. 23, 2024.

(51) Int. Cl. B65B 43/54; A61J 1/06; B65B 3/00; B65B 5/04; B65B 5/06; B65B 5/10; B65B 43/46; B65B 57/04; B65B 61/20; B65B 61/26

(52) U.S. Cl. CPC B65B 43/54; B65B 3/003; B65B 5/045; B65B 5/06; B65B 5/10; B65B 43/465; B65B 57/04; B65B 61/20; B65B 61/26; A61J 1/06; B65B 2220/14

(57) ABSTRACT

An automatic filing system uses a conveyor system to controllably move a plurality of shuttles that are able to hold a bag for packaging the prescription products for delivery as well as shuttles that are able to hold a bin for holding prescription products. The bag-holding shuttles can transport the bags to filling stations that can place products, such as portions of an individual's prescription or other related products, into the bags and then to a sealing station that seals the bag prior to delivery to a sorting station for delivery. The bin-holding shuttles may be used for processing of orders that may require some additional manual intervention in order to complete the order.

### RELATED APPLICATIONS

The current application claims priority to U.S. Provisional Patent Application 63/697,774 filed Sep. 23, 2024 and titled “Automated Packaging System For Prescriptions,” the entire contents of which are incorporated herein by reference in their entirety.

### TECHNICAL FIELD

The current disclosure relates to an automated packaging system for prescriptions and in particular an automated packaging system capable of handling different types of medical products.

### BACKGROUND

Totes or bins are used in automated prescription preparation systems to receive at least one prescriptions and travel along a conveyor to transfer the prescriptions from picking stations to packaging stations, like Pregis Sharp™ Automated Bagging Machines, where flexible packages like bags are opened to receive the prescriptions from the bins and then sealed.

When using a bin to transfer prescriptions for an individual, the products need to be moved from picking stations into the bin, and then from the bin into the bag for delivery. The multiple movements into and out of bins can increase the potential for errors when automatically filling prescriptions.

Further, while a large percentage of prescriptions may be automated, certain prescriptions may require manual intervention in order to fulfill them. The need for such manual intervention can make automation of filling prescriptions difficult.

An additional, alternative, and/or improved system for use in at least partially automating the packaging of prescriptions is desired.

### BRIEF DESCRIPTION OF THE DRAWINGS

Further features and advantages of the present disclosure will become apparent from the following detailed description, taken in combination with the appended drawings, in which:

FIG. 1 depicts an automated packaging system for prescriptions;

FIG. 2 depicts a method for automated packaging of prescriptions;

FIG. 3 depicts a further automated packaging system for prescriptions;

FIG. 4 depicts a bag-holding shuttle;

FIG. 5A depicts the bag-holding shuttle in a closed position; and

FIG. 5B depicts the bag-holding shuttle in an open position.

### DETAILED DESCRIPTION

In accordance with the present disclosure there is provided an automated pharmacy packaging system comprising: a conveyor system capable of individually controlling movement of a plurality of shuttles along a path of the conveyor, the plurality of shuttles comprising: a first plurality of bag holding shuttles equipped with a bag carrying interface; and a second plurality bin shuttles equipped with a bin carrying interface; a bag loading station arranged along the path of the conveyor to load a bag onto a respective bag holding shuttle of the plurality of bag holding shuttles; a first type loading station arranged along the conveyor downstream of the bag loading station, the first type loading station loading one or more items of a first type into a bag or bin held by a respective one of the plurality of shuttles; a second type loading station arranged along the conveyor downstream of the bag loading station, the second type loading station loading one or more second items of the second type into a bag held by a respective one of the plurality of shuttles; and a controller to control movement of the plurality of shuttles along the conveyor, including movement of the plurality of shuttles along the conveyor system to the bag loading station, first type loading station or second type loading station.

In a further embodiment of the system, the system further comprises: a bin loading station for loading one or more bins to a respective bin holding shuttle.

In a further embodiment of the system, the bin loading station transfers bins from a specialty loading area where products of prescription orders are placed in the bins.

In a further embodiment of the system, the products of prescription orders are sealed in a bag and placed in the respective bin.

In a further embodiment of the system, the bin with the sealed bag are transferred back to a bin holding shuttle on the conveyor system.

In a further embodiment of the system, the system further comprises: a labelling system for applying labels to bags, the labels identifying information of the individual the bag is for.

In a further embodiment of the system, the system further comprises a printing station for printing literature associated with drugs in a bag and placing the printed literature into the bag.

In a further embodiment of the system, the system further comprises a sealing station for sealing bags.

In a further embodiment of the system, the system further comprises a transfer station for transferring bags and bins from the conveyor to a sorting location.

In a further embodiment of the system, the transfer station further transfers bags with a packing error to an exception location.

In a further embodiment of the system, the first type loading system comprises a vial loading system and the second type loading system comprises a unit of use (UoU) loading system.

In a further embodiment of the system, each of the bag holding shuttles is able controllably move the bag between an open position and a closed position.

In a further embodiment of the system, the bag holding shuttle comprises a pair of arms each having a bag holding mechanism arranged at ends of the respective arms, the arms moveably mounted to a body of the bag holding shuttle and moveable between the open position and the closed position, wherein in the open position a distance between the bag holding mechanisms on the respective arms is reduced to cause the bag to open, and wherein in the closed position the distance between the bag holding mechanisms on the respective arms is increased to cause the bag to close.

In accordance with the present disclosure there is further provided a method of operating a system according to any of the systems described above, the method comprising: loading a bag onto a bag holding shuttle; moving the bag holding shuttle with the bag to a loading station of a first type; depositing at least one item of the first type associated with a prescription order into the bag; and moving the bag holding shuttle with the bag to a loading station of a second type; depositing at least one item of the second type associated with a prescription order into the bag.

In a further embodiment of the method, the method further comprises: transferring a bin from a bin holding shuttle to a specialty loading area; placing products of prescription orders in a bag and sealing the bag; placing the sealed bag in the bin; and transferring the bin with the sealed bag to a bin holding shuttle.

In accordance with the present disclosure there is further provided a non-transitory computer readable medium, storing instructions which when executed by a processor of a system configure the system to perform a method according to any of the methods described above.

The automatic, or semi-automatic, filling of prescriptions can be provided using a conveyor system which controllably moves a plurality of shuttles that are able to hold a bag for packaging the prescription products. The shuttles can transport the bags to filling stations that can place products, such as portions of an individual's prescription or other related products, into the bags and then to a sealing station that seals the bag prior to delivery to a sorting station for delivery to the user. Moving the bag to the filling stations can reduce the amount of interactions or movements of the products required, which can reduce potential handling errors as well as increase the filling speed. While the prescription filling system described further below can automatically fulfill most prescription orders, there may be certain orders that cannot be automatically filled. For such orders, the automatic system may include addition shuttles that can be used to allow for manually fulfilled prescriptions to be processed alongside the automatically filled prescriptions. As described in further detail below, the system comprises a conveyor system that can controllably move different types of shuttles around. The shuttles include a bag-holding shuttle that can hold bags for automatically fulfilling prescription orders as well as a bin holding shuttle that can be used for the manual filling of prescriptions. The prescription fulfillment system described further below, in addition to providing a system that can handle both automatic and manual filling, can reduce the overall footprint required for fulfilling orders, which can reduce associated costs.

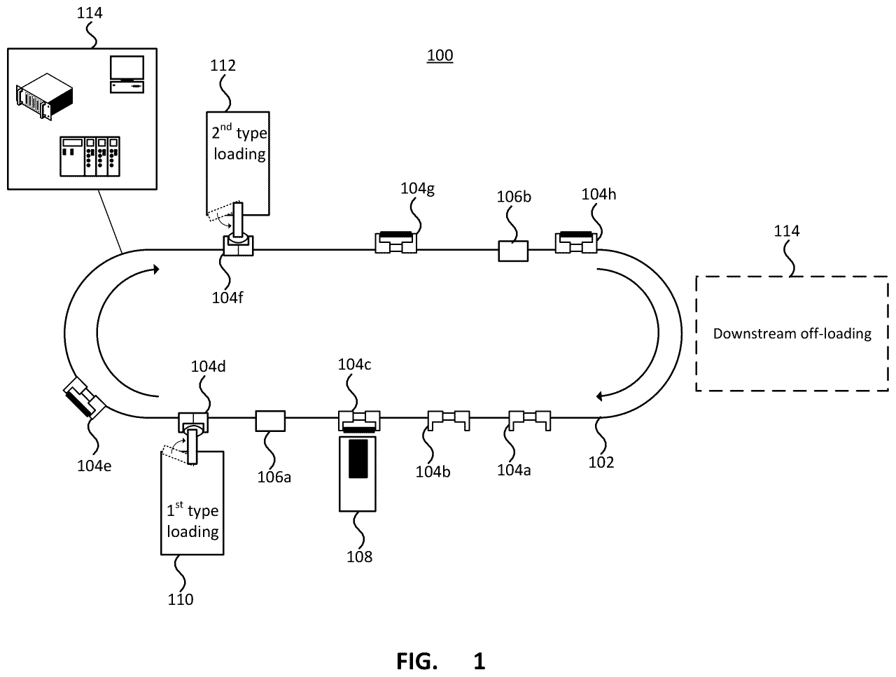

FIG. 1 depicts schematically an automated packaging system for prescriptions. The system 100 includes a conveyor system 102. The conveyor system 102 is depicted as a loop conveyor that travels in a clockwise direction. However, other conveyors may be used. The conveyor may be implemented, for example, as a linear motor conveyor system that can independently control the movement of individual shuttles on the linear track. The individual shuttles may move both forwards and backwards on the conveyor, as well as possibly be transferred to adjacent conveyor sections. As depicted, there are, at least, two types of shuttles that move along the conveyor. A first type of shuttle is a bag-holding shuttle 104a . . . 104h, which can be loaded with a bag, or possibly multiple bags, that the prescription products are placed in. The bag may be used for delivery to an individual, or may be placed in a separate bag or container for delivery. The bag-holding shuttle may hold the bag in an open position to facilitate filling with the required prescription products. The bag-holding shuttle may have an actuator that can controllably open and close the bag while it is carried by the shuttle. The second type of shuttle on the conveyor is a bin-holding shuttle 106a, 106b, which can carry a bin, tray, tote or similar structure, that allows the conveyor 102 to be used with manually fulfilled prescriptions. For example, an individual may manually fill one or more products into a bag which can be placed on the bin-holding shuttle. Further, the one or more products can be automatically placed in a bin by loading stations, which may then be delivered by the conveyor to an individual or other processing functionality to complete the order, such as adding other products or performing other actions. The number of bag-holding shuttles may be greater than the number of bin-holding shuttles; however, the distribution may be based on the anticipated number of prescriptions that can be automatically filled, and so use the bag-holding shuttles, compared to the number of prescriptions needing manual intervention to fulfill and so use the bin-holding shuttles.

The system 100 includes a bag loading station 108 in proximity to the conveyor 102. The bag loading station may load a bag for holding a products or components of an order onto a bag holding shuttle. It is possible that the bag holding shuttle may be adapted to hold multiple bags. The bags may be loaded from a reel or other structure. The bags may be held on the shuttle in a variety of ways. For example, the edges of the bag may be held by clips or other structures on arms that can be extended or retracted in order to open or close the bag. Although depicted as a single bag-loading station, it is possible to have multiple bag-loading stations arranged at the conveyor. The number of bag-loading stations can be determined based on the number of shuttles a single bag-loading station can load compared to the throughput of the fulfillment system.

Once a shuttle is loaded with a bag as depicted by bag-holding shuttle 104c, the shuttle can move to a loading station for loading an item into the bag. The items being loaded may be prescription products of different types. For example, the items may broadly be vials or similar containers or as units-of-use (UoU) products. The different types of items, such as vials and UoUs, may require different arrangements for dispensing the items and as such, may be associated with different loading stations. As depicted a first type loading station 110 can automatically retrieve, or receive, items of the first type for an individual's prescription and load them into the open bag of the bag-holding shuttle arranged at the station, which is depicted as bag-holding station 104d. The bag-holding shuttle 104d is depicted with the holding arms retracted in order to open a top of the bag in order to allow an actuator, depicted as a moveable arm, to place items for the prescription into the open bag. The first item type loading station may load one or more items of a first type into the bag depending upon the particular prescription order. Once the items are loaded into the bag, the shuttle may continue its movement along the conveyor. As depicted by bag-holding shuttle 104e, the holding arms may be extended in order to close the bag during transport. Although it may not be necessary to close the bag during movement of the shuttle, doing so may reduce the potential for issues such as products falling out of the bag, or additional elements falling into the bag.

The bag-holding shuttle may move from the vial loading station 112 to a second type of item loading station 112, which can deposit the items of the second type, if any, into the bag. It will be appreciated that the 2^{nd} type loading station 112 may be arranged before or after the 1^{st} item loading station. A prescription or order for an individual may include one or more items of different types, such as vials and/or UoU products. Once the prescription order for the individual is completed, for example all of the different items needed for the prescription order are loaded into the bag, the bag can be moved to a downstream off-loading section 114. The downstream off-loading section may allow the bagged prescription orders to be further processed for delivery to the individual. This further processing may include one or more of, adding literature, instructions and/or safety information for the prescriptions into the bag, applying a shipping label to the bag, sealing the bag, combining bags into a single package for delivery, and sorting the prescriptions for delivery. For example, the prescription orders may be received from different stores or locations, and the bags may be ordered and grouped together for delivery to the appropriate locations. While certain functions, such as adding literature, labelling and sealing, may be completed downstream from the conveyor 102, it is possible to include one or more stations along the conveyor in order to perform the functions. Further, although not depicted in FIG. 1, it is possible to include a unique identifier on each bag that can be scanned at each loading station in order to ensure that the correct prescription products are being deposited into the correct bag.

FIG. 1, the system 100 includes a controller or control system 114, which may be provided by one or more microprocessors, microcontrollers, ASICS, FPGAs, programmable logic controllers (PLCs), industrial controllers, servers, computers, etc. The controller controls movement of the plurality of shuttles along the conveyor, including movement of the plurality of shuttles along the conveyor system to the bag loading station, vial loading station or UoU station. The controller may also control operation of the vial loading station and UoU station in order to ensure the proper prescription products are loaded into the appropriate bag. As described above, the bag may have a unique identifier that can be used to associate the bag with the particular prescription order being filled. Additionally, or alternatively, the particular prescription order may be associated with a shuttle, which may be uniquely identified and tracked as part of the conveyor system.

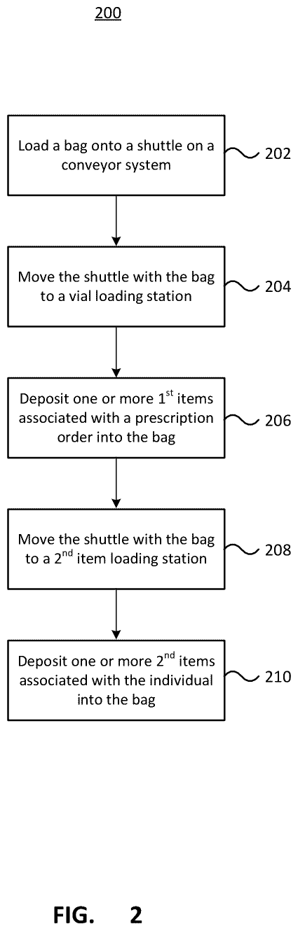

FIG. 2 depicts a method for automated packaging of prescriptions. The method 200 begins with loading a bag onto a shuttle on a conveyor system (202). The bag and/or the shuttle may be associated with a prescription order, which may comprise one or more items, possibly of different types, for an individual or possibly multiple individuals. The shuttle with the bag is moved to a first type loading station (204) and one or more items of the first type associated with the prescription order are deposited into the bag (206). The shuttle and the bag may be moved to another station for loading items of a second type (208). Once at the second loading station, one or more items of the second type can be loaded into the bag and the completed prescription order can be completed, for example by sealing the bag and sorting for delivery.

The above method describes depositing at least one item of a first type and at least one item of a second type into the bag. It will be appreciated that a prescription order may include only a single item type. Further, while described as depositing the first type of items into the bag first, it is possible to deposit the second type of items into the bag before the vials.

The method may further include identifying the bag or shuttle being filled and possibly the prescription items being deposited to ensure the correct prescription order is being completed.

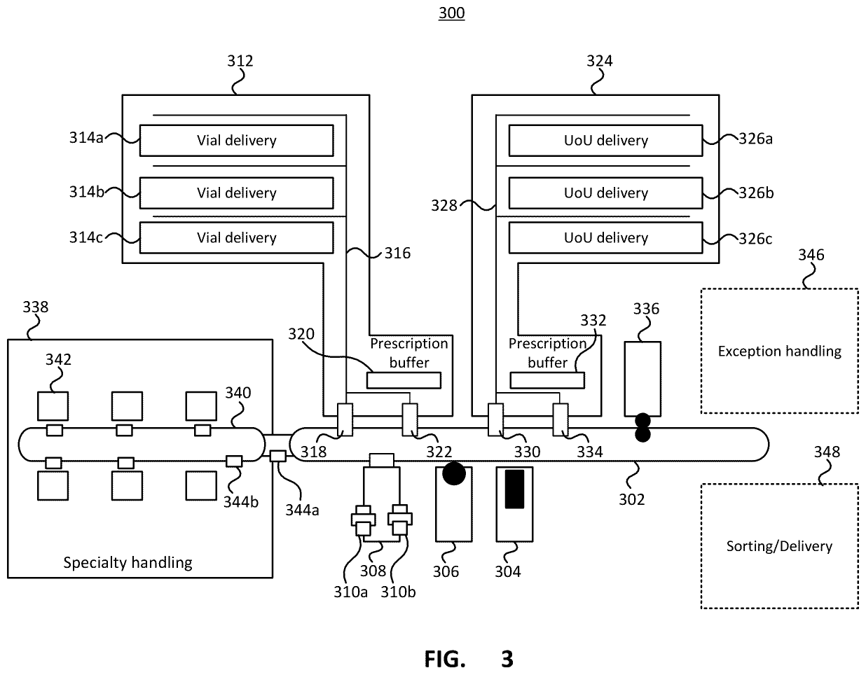

FIG. 3 depicts a further automated packaging system for prescriptions. The above has described a system and method in which the conveyor includes a bag loading station, a first type of item loading station and second type of item loading station. It is noted that FIG. 3 omits the shuttles from the main conveyor for simplicity of the drawings. Further, in FIG. 3, the different items are depicted as vials and a unit of use (UoU) type of item. However, similar to the system 100, the system 300 includes both bag-holding shuttles and bin-holding shuttles. The system 300 is similar to that described above in relation to FIG. 1 however, the system includes additional components. The conveyor 302 is depicted as being arranged in a loop with shuttles moving in a generally clockwise direction. The conveyor can be arranged in other shapes. Similar to the system 100 described above, the system 300 includes one or more bag loading stations 304. Each bag loading station may load one or more bags onto a respective bag-holding shuttle (not shown for clarity of the drawing). The bag loading station may load the same size bag onto each shuttle, or the bag size may vary. For example the bag loading station may select one of a plurality of different sized bags to load on to the bag holding shuttle. When different sized bags are used, the selection of the bag size may be based on the number of products, and/or the size of the products, in a prescription order. Regardless of the size of the bag loaded onto the shuttle, a label may be printed on, or applied to, the exterior of the bag by a labelling station 306. The labelling station may, for example, print a unique identifier such as a barcode, QR code or other similar identifier and/or may print identifying information for the prescription such as an individual's name, address, etc. Regardless of the information included in the label, the labelling station can apply the label to the exterior of the bag, either by printing directly onto the bag, or printing onto a label and affixing the label to the bag. The labelling station 306 may be arranged adjacent to the bag loading station so that the labelling occurs with the bag empty. While this may not be required, and the labelling station can be arranged in different locations, labelling the bag prior to depositing anything into means that the labelling occurs on a substantially flat bag, which may be easier. A vacuum device or actuator can be used to ensure the bag, or a portion of the bag, is on a flat surface to facilitate the labelling. When the labelling station prints a unique identifier onto the bag, it may be cross referenced to the unique identifier associated with the shuttle the bag is loaded on. Although depicted as labelling the bag after it has been loaded onto the shuttle, it is possible to label bags prior to being the bag being loaded onto the shuttle.

A printing station 308, depicted as comprising plurality of printers 310a, 310b can print out any literature, instructions, and/or safety information associated with the prescription products that will be placed in the bag, or possibly affixed to the bag for example as a label. The system may determine the products associated with a prescription order that is associated with a particular bag on a shuttle. Based on the products that will be deposited into the bag, the printing station can print the required, or desired, information and deposit it into the bag. The literature packs can be pre-printed and queued for delivery to the appropriate bag. Various methods may be used to deposit the literature into bags. For example, overhead tooling can push and fold the literature into the bags. The literature deposited in, or affixed to, the bag can be cross-checked against the identifier on the bag and/or the identifier of the shuttle. If any mismatches are identified, the bag may be marked as an exception for further handling.

The bag shuttle may be moved to one or more loading stations, which may include one or more vial loading stations 312, or UoU loading stations 324. The vial loading stations may include a vial dispensing and delivery system which may comprise one or more vial delivery sections 314a . . . 314c that can automatically dispense the required vials for fulfilling prescriptions. The vials can be transported along a delivery conveyor 316 to a either a single load delivery position 318, or if the vial is part of a multi load order, the vials can be moved to a buffer location 320 so that they can be loaded into the same bag from a multi-vial loading location 322. Although the single load and multi load loading locations are depicted as being separate, it is possible to load both single and multi load orders from the same location. For example, the multi-load vials can be buffered at the buffer location 320 until all vials of the order are available, at which point they can be loaded consecutively to the single vial loading station. The vials can be picked and placed into the bag, for example using a robotic arm or actuator, or other loading mechanism. For example, each single vial may be loaded into an indexing wheel that rotates to dispense a single vial at a time directly into open bags. The vials can be dropped directly to open bags using various mechanisms to deposit the vial into the bag, which may simply be releasing the vial to drop into the bag below it. Vial labels can be scanned in the indexing wheel to positively identify the vial and ensure that it is being delivered to the correct bag, which may be identified by scanning an identifier on the bag, and/or based on the shuttle ID that the bag is loaded on. If any errors or discrepancies are found, the shuttle and bag may be marked for further exception handling. The buffer location may use a similar indexing wheel to hold vials, however it is controlled to ensure that vials for the same order are arranged consecutively on the wheel in order to allow all of the vials of an order to be deposited in the same bag. Other options are possible, for example, if vials aren't located consecutively on the wheel, the wheel can be controlled to move to the different locations of the vials of the same order. Buffering vials of the same order to be in consecutive locations may allow a higher delivery speed of vials into the bags as the wheel does not need to move as far to deliver all of the vials.

A unit of use (UoU) loading station 324 may provide similar functionality, including one or more UoU delivery sections 326a . . . 326c that allow UoU products need for an order to be picked and delivered, via one or more delivery conveyors 328. The UoU products may be delivered into the open bag by running the UoU off of the conveyor into a chute over the bag at a single loading station 330. Similar to the multi-load vials, it may be possible to send a UoU product to a buffering area 332 where it can be temporarily buffered until all UoU products of the order are available and can be delivered to the bag at a multi-load UoU loading station 334.

The control system of the automated packaging system may track the processing order of the bags, and the associated prescription on the conveyor. This tracking may be used to determine an order that the bags will arrive at the loading stations, whether at the printing station, vial loading station, UoU loading station or other loading stations present. The bag order, and so the associated prescription order, may be used in order to provide the items, such as the printed literature, vials, UoU, in sequential order to the respective loading system. This coordinated sequential ordering ensures the correct items are placed in the correct bag and minimizes, or reduces, any additional handling of the bags and vials.

As described above, the vial loading station and the UoU loading station may provide for buffering of items being loaded. While the buffers of each loading station are described separately, it is possible that buffering of items are ties together so that if a prescription includes multiple vials and multiple UoU items, both can be buffered in respective buffering locations until all elements of the prescription are ready for depositing in a bag, or bags. Further, while a single buffering area is depicted adjacent the conveyor for the vials and UoUs, the buffering may be provided in various ways, including for example external buffering and/or warehousing systems that can store parts of the order until all elements are available. Further, it is possible to use the conveyor system itself as a buffer. For example, if an order comprises two vials, the first vial may be deposited into the bag and the shuttle and bag may continue to circulate on the conveyor until the second vial is ready for depositing into the bag. Various techniques of buffering order components in order to deposit them directly into a bag are possible.

The above has described a single vial loading station 312 and a single UoU loading station. It is possible to include multiple loading stations in order to increase the packaging throughput of the system. Further, although a particular order of the printing station 308 and the loading stations 312, 324 is depicted in FIG. 3, it will be appreciated that the printed literature and different items may be deposited into the bag in any order.

Once all of the elements of the order, such as the literature and prescription products, are deposited into the bag, and assuming no exceptions are detected at the labelling, literature printing or product delivery stations, the bag can pass through a sealing station 336 in order to close and seal the bag with the prescription products in it. The sealing station may seal the bag using one or more sealing techniques such as heat sealing gluing, taping, and mechanical closures.

A verification system can be included that verifies literature is correctly printed and matches the intended bag/prescription order. If there is any quality issue with the literature and print or if there is a wrong or questionable alignment with the bag such that that the correct literature may not be placed in the correct bag, the verification system may take various actions. For example, upon detecting an issue or possible issue, the automated packaging system may be stopped for immediate resolution of the issue, or the bag may be marked as an exception for further handling. Further, the bag may travel the conveyor multiple times for possible resolutions. For example, in the case of a misprint of the literature, the misprinted literature may be discarded and rather than pausing the conveyor and so all other orders being filled until the literature is re-printed, the shuttle and bag may continue to circulate the conveyor until the literature has been re-printed and is available for depositing into the bag. The conveyance tracking system which can identify the location of individual shuttles on the conveyor may be used to verify correct matching of literature to the bag and/or it may use a more traditional method of scanning both a bag identifier and a literature identifier to verify the match.

The above has described the automated filling of prescriptions that include vials and/or UoU products. While this automated process may fill a majority of prescriptions, it is possible that some prescriptions cannot be automatically filled. This may be for various reasons, such as the order being too large to fit in a standard bag, the inclusion of products that require special handling, one or more of the items not being available for the automated loaded for example because it is of too low volume in orders to automate, and/or the cost to automate the delivery of the item is too expensive to make the automation make financial sense. Such products may be high-value medicines or medicines requiring extra handling precautions, etc. Such medicines can be handled by a specialty handling area 338 using the bin holding shuttles. The bins may be transferred from the bin holding shuttles on the main conveyor 302 and either moved manually within the specialty handling area 338 or loaded on to bin holding shuttles on conveyor within the specialty handling area 338, and then once the prescription completed, the bin can be loaded back to a bin holding shuttle on the main conveyor 302. Additionally or alternatively, rather than moving the bin, while the bin holding shuttle remains on the main conveyor 302, the bin and the bin holding shuttle may be transferred from the main conveyor 302 to the conveyor in the specialty handling area 338.

For prescription orders that cannot be automatically filled, one or more bin holding shuttles, or bins from the bin holding shuttles, can be transferred to the specialty handling area 338 as depicted by bin holding shuttle 344a. The bins, or bin holding shuttles 344a, 344b, can be moved on a conveyor to one or more fulfillment stations 342 where an individual, such as a pharmacist can load the products into a bag. The sealed bag may be returned to the bin, and the bin moved back to the main conveyor line 302. It is possible for an order to include both products requiring special handling as well as products that can be fulfilled automatically. In such a case, the products, such as vials and UoUs, can be automatically filled onto a bin instead of a bag. The printed literature can be included in the bin. Once the vials and/or UoUs for the order are placed on a bin, the bin can continue around the conveyor system 302 for transfer to the specialty handling area 338 in order to package the vials/UoUs with the specialty products. The complete order can be sealed in a delivery bag and the bag returned to the bin and subsequently the main conveyor 302.

As described above, the different stations may verify that the correct contents are placed in the correct bag. If there is an exception, for example the wrong product was placed in the bag, the product was not successfully placed in the bag, the bag did not seal properly, or other potential exceptions, the bag, or bin holding a bag, can be moved to an exception handling area 346 for inspection and manual handling. The manual handling may involve completing the order if possible or marking the order for redoing by the system 300 and returning any products to be reused or disposed of as appropriate. For the completed orders that were successfully completed, the orders can be sent to a sorting delivery locations 348.

The automated system described above can handle both automatic and manual fulfilment of prescription orders. While the particular implementation of the system will depend on the size of the conveyors, speed of the conveyors, number of shuttles, number of stations, etc. it is possible for a system similar to that of FIG. 3 to handle thousands to 10,000+ orders an hour, although the automation system may still be used with lower volume of orders such as less than 1000 orders an hour, while handling both automated packaging and manual packaging.

The above has described various components of an automated packaging system. The system may include additional elements not depicted in the figures. For example, one or more areas or stations may be provided in order to allow a human to validate the products either before or after being delivered to the bag. Similarly, other visual validations, or other types of validations such as weight based validations that ensure the weight of the bag matches the weight of the individual products deposited into the bag, may be used to ensure the correct items are being deposited into the bag. Further, while the system is described as depositing customer deliverables, such as printed literature and products, into the bag, other items may be deposited in the bag such as RFID tags for tracking, desiccant packets, promotional materials, etc.

While the above has described the automated packaging system as automatically loading vials and/or UoU products into a bag according to a prescription, a similar system may be used for completing other orders in which different types of loading stations are used to deposit customer deliverables into a bag, or other container, used to deliver the order components to the user.

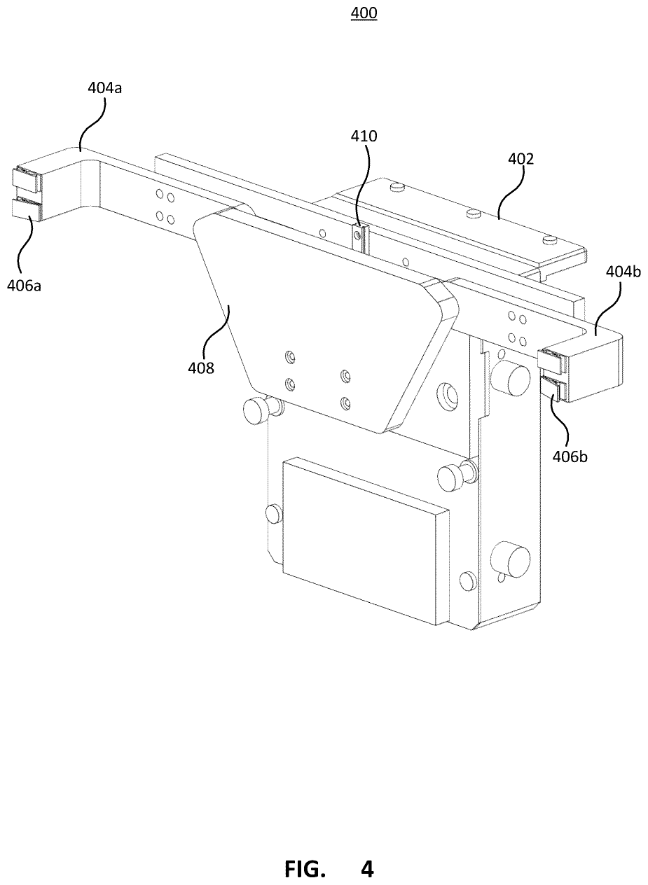

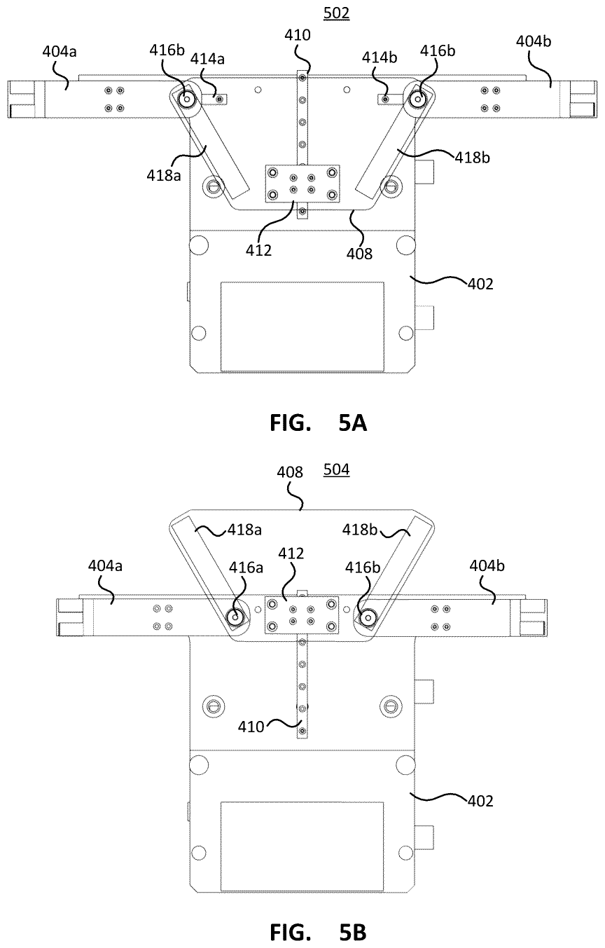

FIG. 4 depicts a bag-holding shuttle. FIG. 5A depicts the bag-holding shuttle in a closed position 502. FIG. 5B depicts the bag-holding shuttle in an open position 504. While a particular bag holding shuttle is depicted in FIG. 4-5B, it will be appreciated that a wide range of implementations are possible, such as a finger mechanism, vacuum mechanism and/or a pinching mechanism. Further, the particular implementation depicted in FIG. 4-5B include a controllable mechanism that can open and close a top of the bag. It is possible to provide a bag holding shuttle that holds the bag in an open position.

The shuttle 400 may have a main body 402 that mounts the shuttle to the conveyor. It will be appreciated that the shape and size of the main body 402 will depend upon the conveyor the shuttle works with. In the case of a linear motor conveyor, the shuttle may have one or more wheels or bearings that bear against a corresponding track. The shuttle may include a magnet or magnetic array that allows the linear motor conveyor to controllable move the shuttle along the track. Other features for uniquely identifying the shuttle and its position along the track can be included on the shuttle.

A pair of arms 404a, 404b are moveably mounted to the main body. The arms may include one or more devices, depicted as clips 406a, 406b that can releasably hold edges of a bag. Although depicted as clips, other mechanisms for securing the bag to the shuttle are possible. The arms 404a, 404b may be slidably mounted to the main body 402 via a linear rail 414a, 414b or guide. The arms can move in and out on the rails. Bushings or guides 416a, 416b are connected to each arm and are received within respective channels 418a, 418b of a moveable element 408. The moveable element 408 may be moveably mounted to the main body 402 via a vertically arranged liner rail 410 or guide. A bearing block 412 may slide on the rail and be fixed to the moveable element 408. When the moveable element is raised or lowered on the guide rail 410, the bushings 416a, 416b connected to the arms 404a, 404b can move within the angled channels 418a, 418b of the moveable element. This causes the arms to extend and retract along the guide rails, which can cause the bags to open or close.

The moveable element 408 can be controlled in various ways. For example, a motor or electronic actuator can be provided on the shuttle in order to move the moveable element. Additionally or alternatively, the moveable element may be biased into the opened or closed position for example by a biasing spring or member. The moveable element can then be moved against the biasing force, possibly by an actuator or element at one or more of the stations. Further, it is possible that the moveable element can be moved to an open or closed position and locked in the position.

It will be appreciated by one of ordinary skill in the art that the system and components shown in FIG. 1-5B may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. An automated pharmacy packaging system comprising:
a conveyor system capable of individually controlling movement of a plurality of shuttles along a path of the conveyor, the plurality of shuttles comprising:
a first plurality of bag holding shuttles equipped with a bag carrying interface; and
a second plurality bin shuttles equipped with a bin carrying interface;
a bag loading station arranged along the path of the conveyor to load a bag onto a respective bag holding shuttle of the plurality of bag holding shuttles;
a first type loading station arranged along the conveyor downstream of the bag loading station, the first type loading station loading one or more items of a first type into a bag or bin held by a respective one of the plurality of shuttles;
a second type loading station arranged along the conveyor downstream of the bag loading station, the second type loading station loading one or more second items of the second type into a bag held by a respective one of the plurality of shuttles; and
a controller to control movement of the plurality of shuttles along the conveyor, including movement of the plurality of shuttles along the conveyor system to the bag loading station, first type loading station or second type loading station.

2. The system of claim 1, further comprising:
a bin loading station for loading one or more bins to a respective bin holding shuttle.

3. The system of claim 2, wherein the bin loading station transfers bins from a specialty loading area where products of prescription orders are placed in the bins.

4. The system of claim 3, wherein the products of prescription orders are sealed in a bag and placed in the respective bin.

5. The system of claim 4, wherein the bin with the sealed bag are transferred back to a bin holding shuttle on the conveyor system.

6. The system of claim 1, further comprising:
a labelling system for applying labels to bags, the labels identifying information of the individual the bag is for.

7. The system of claim 1, further comprising a printing station for printing literature associated with drugs in a bag and placing the printed literature into the bag.

8. The system of claim 1, further comprising a sealing station for sealing bags.

9. The system of claim 1, further comprising a transfer station for transferring bags and bins from the conveyor to a sorting location.

10. The system of claim 9, wherein the transfer station further transfers bags with a packing error to an exception location.

11. The system of claim 1, wherein the first type loading system comprises a vial loading system and the second type loading system comprises a use (UoU) loading system.

12. The system of claim 1, wherein each of the bag holding shuttles is able controllably move the bag between an open position and a closed position.

13. The system of claim 12, wherein the bag holding shuttle comprises a pair of arms each having a bag holding mechanism arranged at ends of the respective arms, the arms moveably mounted to a body of the bag holding shuttle and moveable between the open position and the closed position, wherein in the open position a distance between the bag holding mechanisms on the respective arms is reduced to cause the bag to open, and wherein in the closed position the distance between the bag holding mechanisms on the respective arms is increased to cause the bag to close.

14. A method of operating a system according to claim 1, the method comprising:
loading a bag onto a bag holding shuttle;
moving the bag holding shuttle with the bag to a loading station of a first type;
depositing at least one item of the first type associated with a prescription order into the bag; and
moving the bag holding shuttle with the bag to a loading station of a second type;
depositing at least one item of the second type associated with a prescription order into the bag.

15. The method of claim 14, further comprising:
transferring a bin from a bin holding shuttle to a specialty loading area;
placing products of prescription orders in a bag and sealing the bag;
placing the sealed bag in the bin; and
transferring the bin with the sealed bag to a bin holding shuttle.

16. A non-transitory computer readable medium, storing instructions which when executed by a processor of a system configure the system to perform the method of claim 14.
